(19) United States
(12) Patent Application Publication
(10) Pub. No.: US 2026/0039570 A1
(43) Pub. Date: Feb. 5, 2026

(54) ACCESS POINT QUERY REPORT WITH EXPIRY IMMINENCE

(71) Applicant: Cisco Technology, Inc., San Jose, CA (US)

(72) Inventors: Malcolm M. SMITH, Richardson, TX (US); Binita GUPTA, San Diego, CA (US); Brian D. HART, Sunnyvale, CA (US)

(21) Appl. No.: 19/272,868

(22) Filed: Jul. 17, 2025

Related U.S. Application Data
(60) Provisional application No. 63/677,900, filed on Jul. 31, 2024.

(51) Int. Cl. H04L 43/026; H04W 28/02; H04W 74/04; H04W 74/0816

(52) U.S. Cl. CPC H04L 43/026; H04W 28/0278; H04W 74/04; H04W 74/0816

(57) ABSTRACT

The present disclosure provides techniques for expiry imminence reporting in multi-AP coordination (MAPC). A first AP collects traffic metadata associated with a data flow. The first AP collects an expiry imminence metric for the data flow based on the traffic metadata. The first AP encodes the expiry imminence metric into a coordination message, and transmits the coordination message to a second AP for engaging in access scheduling coordination.

### CROSS-REFERENCE TO RELATED APPLICATIONS

This application claims benefit of co-pending U.S. provisional patent application Ser. No. 63/677,900 filed Jul. 31, 2024. The aforementioned related patent application is herein incorporated by reference in its entirety.

### TECHNICAL FIELD

Embodiments presented in this disclosure generally relate to wireless communication. More specifically, embodiments disclosed herein relate to expiry imminence reporting in multi-access point coordination (MAPC).

### BACKGROUND

Wireless communication standards are evolving to incorporate multi-access point coordination (MAPC) technologies to improve network efficiency and reduce interference. These MAPC modes include, for example, coordinated time division multiple access (C-TDMA), coordinated spatial reuse (C-SR), multi-access point coordination service periods (MAPC-SPs), coordinated restricted target wake time (C-RTWT), coordinated orthogonal frequency-division multiple access (C-OFDMA), coordinated beamforming (C-BF), and coordinated joint transmission (C-JT). These approaches provide new mechanisms for temporal and spatial coordination across access points (APs). However, for effective implementation of such coordination, conventional traffic indicators such as traffic identifiers (TIDs) or buffer occupancy may not be sufficient to convey the urgency of delivery. The exchange of more granular and flow-specific information is needed to reflect the time-sensitive attributes for more precise scheduling and prioritization across coordinated APs.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless network architectures supporting multi-access point coordination (MAPC), according to some embodiments of the present disclosure.

FIG. 2 depicts example data flows with varying expiry imminence values, according to some embodiments of the present disclosure.

FIG. 3 depicts an example workflow for expiry imminence computation and communication, according to some embodiments of the present disclosure.

FIG. 4 depicts an example method for computing, encoding, and reporting expiry imminence in a MAPC environment, according to some embodiments of the present disclosure.

FIG. 5 is a block diagram depicting a method for expiry imminence computation and reporting, according to some embodiments of the present disclosure.

FIG. 6 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including collecting, by a first access point (AP), traffic metadata associated with a data flow, calculating, by the first AP, an expiry imminence metric for the data flow based on the traffic metadata, encoding, by the first AP, the expiry imminence metric into a coordination message, and transmitting, by the first AP, the coordination message to a second AP for engaging in access scheduling coordination.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### EXAMPLE EMBODIMENTS

Wireless communication standards are being developed to incorporate multi-access point coordination (MAPC) technologies for improved spectrum efficiency. These MAPC modes include, for example, coordinated time division multiple access (C-TDMA), coordinated spatial reuse (C-SR), multi-access point coordination service periods (MAPC-SPs), coordinated restricted target wake time (C-RTWT), coordinated orthogonal frequency-division multiple access (C-OFDMA), coordinated beamforming (C-BF), and coordinated joint transmission (C-JT). These approaches provide tight scheduling and improved channel reuse across multiple APs.

To fully achieve the potential of these MAPC technologies, participating APs may benefit from exchanging more granular and time-sensitive flow metadata, such as data that reflects the urgency or deadline constraints of buffered or expected traffic. The shared metadata enables APs to make informed decisions about which traffic flows should be prioritized in upcoming coordinated transmission opportunities.

In existing solutions, flow urgency is typically inferred from conventional quality of service (QoS) indicators like traffic identifier (TID) or access category (AC). This approach is appropriate in Wi-Fi 6-based networks, where QoS granularity is limited and generally relies on fixed category-based prioritization (e.g., voice before video). However, it is not sufficient for Wi-Fi 7/9-based networks, which are designed to support near-deterministic applications (e.g., 4K video, augmented reality (AR), virtual reality (VR), industrial Internet-of-Things (IoT), and autonomous mobile robots (AMRs)). These applications often specify explicit latency and reliability requirements, such as those expressed via stream classification service (SCS) quality of service characteristics (QC). The defined latency and reliability metadata enable further differentiation within a given TID or AC on a per-flow basis.

The present disclosure provides methods, systems, and apparatuses that enable an AP or other coordination network entity to compute, encode, and exchange expiry imminence metrics associated with expected downlink (DL) and/or uplink (UL) traffic. These metrics quantify how close a given data flow is to exceeding its QoS-defined delivery deadline, and can be used to make scheduling and prioritization decisions across APs. The metrics may be exchanged across APs during MAPC procedures (e.g., via AP query report protocol (AQRP) messaging), so that each AP can integrate urgency information into shared resource scheduling.

The disclosed methods herein may be applied in both private and enterprise wireless networks. The disclosed methods may be particularly suitable for enterprise deployments, which often support ultra-low latency or time-deterministic traffic (e.g., AR/VR, 4K video streaming, industrial IoT). Additionally, enterprise APs are capable of inferring per-flow deadlines even without explicit stream classification service (SCS) signaling, such as via media access control (MAC) service data unit (MSDU) timeout information, deep packet inspection (DPI)-based classification, or application-layer policies. The information may be used to estimate expiry imminence and prioritize traffic accordingly in coordinated operations.

The disclosed techniques apply to both DL and UL traffic, and to both expected (e.g., scheduled via SCS or restricted target wake time (R-TWT)) and unexpected (e.g., buffered) data flows. In the DL case, participating APs in a MAPC operation (particularly under C-TDMA) may compute the accrued delay of specific flows, either per flow or per TID/AC, and compare it against a target delay or not-to-exceed (NTE) latency threshold. These targets may be determined based on information such as default TID/AC assignments, per-application configurations, application-layer classifications derived from deep packet inspection (DPI), application visibility and control (AVC), or explicit SCS signaling. In the UL case, where traffic is buffered at the client station (STA), the APs may solicit queue state information using an enhanced buffer status report (BSR) (which may include parameters like queue depth (QDepth) or head-of-line (HOL) delay) or may infer expected arrival timing based on the last burst of a known periodic flow that is observable at the client's MAC layer (as derived from an SCS QoS characteristics (QC) schedule).

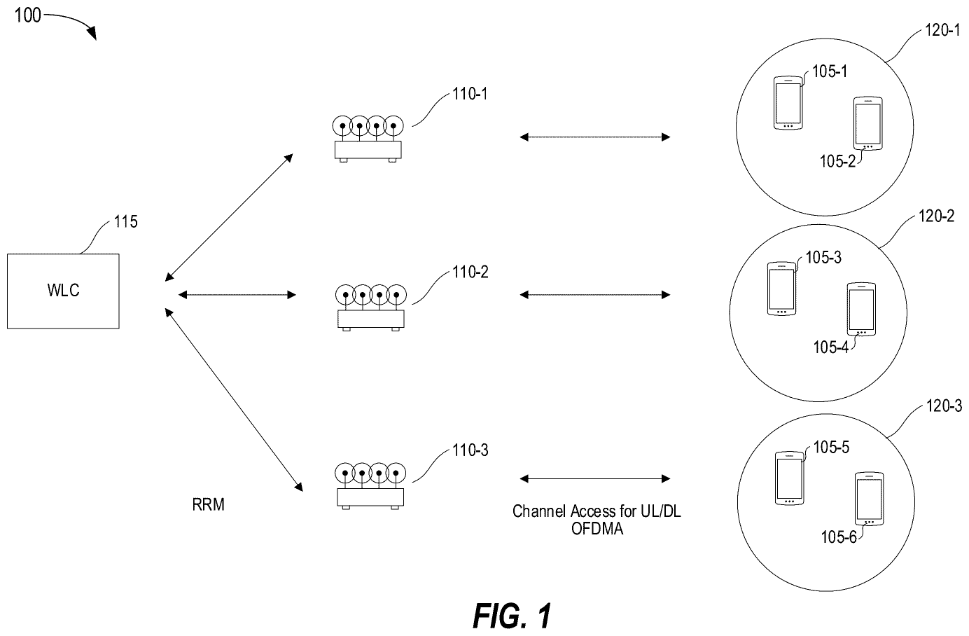

FIG. 1 depicts an example MAPC-enabled wireless network environment 100. As depicted, the example environment 100 includes a controller 115 (e.g., a wireless local area network (LAN) controller (WLC)) that is coupled to a plurality of access points (APs) 110-1, 110-2, and 110-3. Each AP 110 serves as a set of stations (STAs) 105 located within its coverage area 120. Specifically, AP 110-1 is associated with STAs 105-1 and 105-2 (as depicted within the coverage area 120-1), AP 110-2 is associated with STAs 105-3 and 105-4 (as depicted within the coverage area 120-2), and AP 110-3 is associated with STAs 105-5 and 105-6 (as depicted within the coverage area 120-3).

As shown, the controller 115 coordinates radio resource management (RRM) across the APs. Through RRM, the controller 115 may assign operational parameters to each AP, such as frequency channels, transmit power levels, or relevant time synchronization information. In some embodiments, RRM may also serve as the framework for MAPC procedures. In some embodiments, MAPC may be implemented in a distributed manner, with APs 110 exchanging coordination data directly using MAPC signaling protocols, such as the AP query report protocol (AQRP).

All APs 110-1 through 110-3 participate in coordinated UL and DL transmissions using mechanisms such as orthogonal frequency division multiple access (OFDMA). Coordinated access allows for more efficient spectrum utilization and reduced interference. When MAPC is enabled, different coordination modes may be deployed. These may include, for example, coordinated time division multiple access (C-TDMA), coordinated spatial reuse (C-SR), multi-access point coordination service periods (MAPC-SPs), coordinated restricted target wake time (C-RTWT), coordinated orthogonal frequency-division multiple access (C-OFDMA), coordinated beamforming (C-BF), and coordinated joint transmission (C-JT).

In conventional systems, prioritization of traffic is often based on access category (AC) or traffic identifier (TID). For example, traffic classified as voice (AC_VO) is prioritized over video (AC_VI). If STA 105-1 is engaged in a voice call via AP 110-1, and STA 105-3 is streaming video content via AP 110-2, the scheduler may prioritize the STA 105-1 flow due to its higher AC classification.

However, such static category-based prioritization is insufficient for enterprise deployments that support deterministic or (near-)real-time traffic. More specifically, next-generation applications (e.g., AR/VR, industrial automation, or low-latency sensor data) may have strict, per-flow latency limits that are not adequately captured by TID or AC values. As a result, the APs may misprioritize flows that are nearly expired but fall under a lower-priority AC (e.g., VI), or over-prioritize flows with relaxed deadlines that merely have a high-priority label.

To address these limitations, APs 110 may communicate flow-specific information that reflects the urgency or imminence of data transmission needs. Specifically, each AP 110 may compute an expiry imminence metric. As used herein, the expiry imminence metric represents the time remaining before a packet or data flow is expected to expire (e.g., exceeding its allowable delivery deadline). The metrics may be determined based on various factors, including the total local queue states, application-specific delay bounds, or explicit timing parameters obtained via SCS or other classification mechanisms.

Once computed, the expiry imminence metric may be communicated between APs, either directly, using AQRP, or via aggregation and redistribution through the controller 115. With access to expiry imminence data across the network, the APs 110 can make coordinated scheduling decisions that consider the relative urgency of traffic across their respective coverage areas.

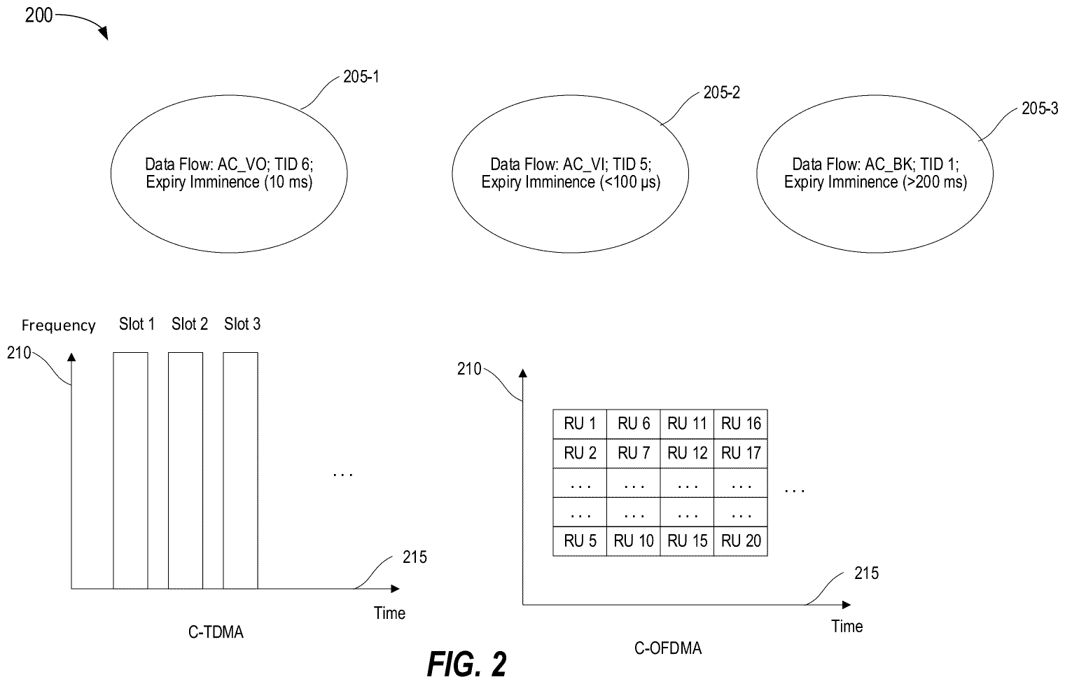

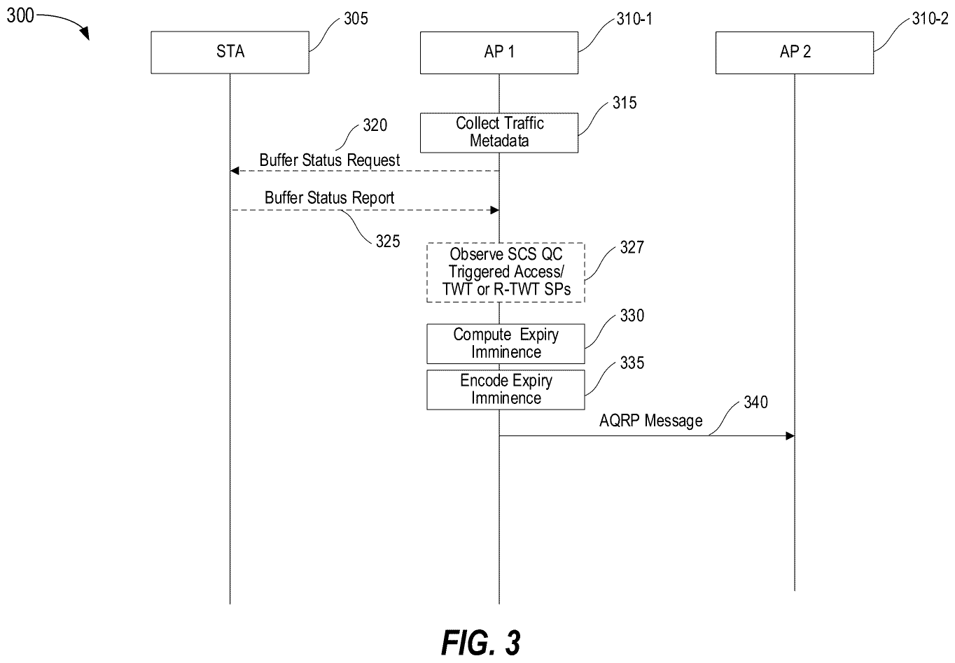

For example, if AP 110-1 is serving STA 105-1, which is transmitting time-sensitive industrial control data nearing its expiry deadline (e.g., <100 μs), and AP 110-2 is serving STA 105-3, which is streaming buffered video content with a more relaxed latency requirement (e.g., 200-400 μs), the expiry imminence allows the network to prioritize the STA 105-1 flow during coordinated MAPC operations (e.g., C-TDMA) scheduling. The sharing avoids the limitations of conventional category-based prioritization (e.g., AC/TID), which may not capture the real-time urgency. More details about expiry imminence calculation and reporting are discussed below with reference to FIGS. 2 and 3.

FIG. 1 depicts an example wireless environment 100 in which a controller 115 is connected to three APs. The example is provided for conceptual clarity. In some embodiments, the network may include any number of APs (including one), and each AP in the network may be associated with any number of STAs within its coverage area. The specific arrangement of APs and STAs may vary according to enterprise requirements, building layout, and radio planning considerations.

FIG. 2 depicts example data flows with varying expiry imminence values. FIG. 2 also illustrates how transmission resources may be allocated under C-TDMA and C-OFDMA coordination modes.

As depicted, three example data flows 205 within a multi-AP wireless environment are provided. Each data flow 205 is associated with different application types, AC/TID, and expiry imminence values. Data flow 205-1 corresponds to voice traffic, classified under AC_VO and assigned TID 6. Voice traffic generally receives high QoS priority. In the depicted example, however, data flow 205-1 has just entered the transmission queue and exhibits an expiry imminence of approximately 10 milliseconds, which indicates moderate urgency.

Data flow 205-2 corresponds to live video traffic, such as part of a real-time streaming session, and is classified under AC_VI with TID 5. Although AC_VI has lower priority than AC_VO in conventional scheduling, data flow 205-2 is nearing its application deadline, with an expiry imminence of less than 100 microseconds. The expiry imminence value indicates high urgency.

Data flow 205-3 is associated with background data traffic. The data flow 205-3 is classified under AC_BK with TID 1. The data flow 205-3 has a relaxed delivery requirement and an expiry imminence of approximately 200 milliseconds, indicating low urgency. Each of these data flows 205 may be DL or UL and may originate from any AP or STA in the system architecture shown in FIG. 1.

The expiry imminence value may be calculated in several ways. In one embodiment, expiry imminence is calculated as the difference between the MAC service data unit (MSDU) expiry delay and the current queue delay. An example equation is provided as follows:

$$expiryImminence = msduExpiryDelay - queueDelay$$

The equation applies when the AP or STA has knowledge of the absolute expiration time of a packet (e.g., an MSDU timeout). As used herein, msduExpiryDelay refers to how long a packet can be buffered before it becomes irrelevant or should be discarded. As used herein, queueDelay refers to the current time that the MSDU has already spent waiting in the transmission queue. The calculation result indicates how much remaining buffer time is left before expiration.

In another embodiment, expiry imminence may be defined as the difference between a statistical delay bound and the same queue delay. An example equation is provided as follows:

$$expiry Imminence = delayBound - queueDelay$$

This approach is used when the system applies statistical or application-specific delay targets. As used herein, the delayBound is the maximum time most MSDUs (e.g., 99% or 99.99%) can be delayed without violating the application's QoS requirements. As used herein, queueDelay represents how long the MSDU has already been buffered. The computation supports bounded-latency applications such as video or industrial sensing, where near-real-time constraints apply without a hard deadline.

In embodiments where traffic is scheduled in advance through coordination mechanisms such as the stream classification service (SCS) or target wake time (TWT), expiry imminence may instead be calculated using the scheduled expected start time. An example equation is provided as follows:

$$expiry Imminence = expectedStartTime - currentTime$$

The expectedStartTime may be learned from SCS QoS Characteristics Information elements or from the negotiated start of a TWT session, and the currentTime is the time at which the AP is performing the computation. This approach allows the system to align delivery windows for scheduled periodic traffic, such as sensor bursts or synchronized uplink streams.

Each AP may select the appropriate calculation method for a given flow depending on what metadata is available, whether explicit (e.g., from SCS) or implicit (e.g., from DPI or AVC classification).

The data flows 205 may represent either DL or UL traffic. When the flow 205 is in the DL direction, the AP may compute the expiry imminence directly based on its internal queue state. This includes measuring the current queue delay (e.g., queueDelay) and retrieving application-specific timing information (e.g., msduExpiryDelay, delayBound, expectedStartTime). Such information may be obtained from default AC or TID assignments, from per-application timeout configurations, or through classification techniques such as DPI or AVC. In some embodiments, the AP may also rely on explicit signaling, such as SCS metadata, including QoS Characteristics Information elements that define expected transmission timing or deadlines.

For UL traffic, where the data is buffered at the client STA, the AP does not have direct visibility into the queue state. In one embodiment, the AP may issue an enhanced BSR request to the STA to obtain metadata such as queue depth, head-of-line (HOL) delay, or buffer aging information. In other embodiments, the AP may estimate the expiry imminence based on implicit timing cues, such as the last burst of a known periodic flow that is scheduled according to a SCS profile or a TWT schedule. The AP may then apply the appropriate equation, based on delay bounds, expected start times, or estimated expirations, to compute or approximate the expiry imminence value.

Under conventional QoS mechanisms, transmission priority is determined primarily based on AC or TID. In such schemes, data flows associated with higher-priority ACs (e.g., AC_VO) are prioritized over flows with lower classifications (e.g., AC_VI or AC_BK). Applying this logic to the data flows 205 illustrated in FIG. 2, the transmission order would follow the static AC-based priority: Flow 205-1>Flow 205-2>Flow 205-3. This is because data flow 205-1 is voice (TID 6, AC_VO), data flow 205-2 is video (TID 5, AC_VI), and data flow 205-3 is background traffic (TID 1, AC_BK). However, in the present disclosure, the APs may evaluate both AC/TID classification and expiry imminence when determining scheduling priority, which allows more accurate reflection of a flow's real-time urgency. In the example shown, although data flow 205-2 is categorized as video, it is nearing expiration with an expiry imminence of less than 100 microseconds. Data flow 205-1, although classified as voice, has a more relaxed imminence of around 10 milliseconds. Therefore, the effective priority order is as follows: Flow 205-2>Flow 205-1>Flow 205-3. The order better aligns with actual delivery constraints.

The dynamic and expiry-based prioritization may be implemented when MAPC modes are enabled. One such MAPC mode is C-TDMA, in which frequency resources are reserved and reused in the time domain. In C-TDMA, the available transmission bandwidth is partitioned into discrete time slots (e.g., Slot 1, Slot 2, and Slot 3), each assigned to a participating AP. The discrete time slots enable contention-free operation and reduced collision probability.

As depicted, the horizontal axis (x-axis) 215 represents time, and the vertical axis (y-axis) 210 represents frequency bandwidth (e.g., a 20 MHz channel). The figure shows a sequence of three time slots: Slot 1, Slot 2, and Slot 3. Based on the computed expiry imminence values and AC//TID, the APs (e.g., 110 of FIG. 1) schedule flows accordingly. For example, data flow 205-2, with the highest expiry urgency (<100 μs), is assigned to Slot 1 to provide immediate transmission. Data flow 205-1 has moderate urgency (10 ms) and is assigned to Slot 2. Data flow 205-3 has low urgency (>200 ms), is scheduled in Slot 3, or is possibly deferred if resources are constrained.

Another MAPC mode is C-OFDMA, where both time and frequency resources are divided into smaller, orthogonally separate units known as resource units (RUs). Each OFDMA transmission opportunity may span one or more time slots, and within each slot, the frequency spectrum is subdivided across multiple RUs that can be assigned independently to different flows or APs.

In the C-OFDMA example shown in FIG. 2, the first time slot includes RUs 1 to 5, the second slot includes RUs 6 to 10, the third time slot includes RUs 11 to 15, and the fourth slot includes RUs 16 to 20. Flow assignments are guided by expiry imminence and AC/TID. Data flow 205-2 is the most urgent and therefore is mapped to RUs 1 to 5 in the first slot. Data flow 205-1 is assigned to RUs 6 to 10 in the second slot, and data flow 205-3, with the least urgency, is placed in RUs 11 to 15 or in a later transmission window.

The number of RUs assigned to each flow in the C-OFDMA example may vary depending on several factors, including the size of the buffered data, the modulation and coding scheme (MCS), the flow's airtime requirement, and channel conditions. The assignment discussed above—with flow 205-2 mapped to RUs in the first slot, flow 205-1 mapped to RUs in the second slot, and flow 205-3 mapped to RUs in the third slot—is provided for conceptual clarity, to demonstrate the relative prioritization based on expiry imminence. In some embodiments, flows with larger data payloads or more aggressive MCS profiles may be assigned multiple continuous RUs or higher bandwidth segments to complete transmission within the allowed window.

The described expiry-based prioritization framework is not limited to C-TDMA and C-OFDMA. It may be applied to other MAPC modes, such as C-SR (where per-flow urgency may be used to influence spatial transmission patterns), C-RTWT (where per-flow urgency may be used to adjust wake time intervals), or C-TJ (where per-flow urgency may be used to adapt AP participation in joint data delivery).

The three data flows 205 depicted in FIG. 2 are examples provided for conceptual clarity. In real-world deployment, APs may be managing a large amount of concurrent data flows, each with distinct traffic characteristics, QoS requirements, and expiry behaviors. The dynamic prioritization and resource assignment described herein may scale across such multi-flow environments, and provide per-packet or per-TID prioritization that better aligns with real-time application demands.

FIG. 3 depicts an example workflow 300 between an AP and a client STA for computing and reporting expiry imminence in a MAPC environment. AP 1 (310-1) may correspond to AP 110-1 in FIG. 1, and AP 2 (310-2) may correspond to AP 110-2 in FIG. 2. The STA 305 may correspond to one of the STAs associated with AP 1, such as STA 105-1 in FIG. 1. AP 1 and AP 2 are within a coordination group and participating in MAPC procedures. STA 305 is associated with AP 1, and AP 1 is configured to compute the expiry imminence of one or more data flows between the AP 1 and STA 305.

As depicted, AP 1 first collects the traffic metadata for imminence computation (as depicted by step 315). For DL traffic, the metadata may include queue delay information for the relevant flow or TID, along with application-level metadata such as delay bounds, MSDU expiry times, or expected transmission schedules. The data may be determined from internal queue states, application classification (e.g., via DPI or AVC), or explicit QoS signaling (e.g., SCS QoS characteristics). For UL traffic, where the data resides in the transmission buffers of the STA, additional signaling may be implemented. In one embodiment, AP 1 transmits a buffer status request (or scheduling trigger) to solicit metadata about the STA's current UL queue state (as depicted by step 320). In response, the STA 305 may return a buffer status report (BSR) (as depicted by step 325), which may include metadata such as queue depth, HOL delay, or other flow characteristics. With the received information, AP 1 may estimate the queue delay and, when combined with policy or schedule information (e.g., from SCS or TWT), derive relevant timing data for expiry computation.

In other embodiments, in addition to or instead of explicit buffer status reporting, AP 1 may also infer uplink timing information by observing locally known scheduling metadata. AP 1 may reference SCS QoS Characteristics (QC) Triggered Uplink Access intervals or TWT or R-TWT service periods (SPs) associated with the STA (as depicted by step 327). These scheduled access intervals allow the AP to predict expected uplink transmission times.

With the obtained metadata, whether from BSR or from scheduled observation, the AP 1 computes the expiry imminence for one or more data flows (as depicted by step 330). One of three example equations may be used, as discussed above. For example, the AP may calculate expiry imminence based on an absolute expiry deadline (e.g., an MSDU timeout), a bounded delay target (e.g., a statistical latency bound), or a scheduled transmission window (e.g., a next expected start time defined by SCS or TWT parameters).

Once the expiry imminence value is computed, the AP 1 (310-1) proceeds to encode the result into a compact representation suitable for signaling (as depicted by step 335). In some embodiments, the expiry imminence may be encoded as an unsigned integer field, such as an 8-bit value, or through other bit widths, like 6 or 10 bits. The encoded value may be expressed in units of time, such as milliseconds (μs), microseconds (ms), or time units (TU), where the scale may be, for example, 0.5 TU or 2 ms.

The encoding scheme may be configured such that lower numerical values indicate higher urgency, representing that traffic needs to be transmitted almost immediately. In contrast, higher values indicate relaxed urgency or later deadlines. For example, a maximum value (e.g., 255 ms in an 8-bit format) may represent nominal delay tolerance. In some embodiments, a special value such as 0 may be reserved to indicate that expiry imminence is unknown, undefined, or nominal.

To reduce signaling overhead, in some embodiments, an exponential encoding scheme may be used for linear encoding. For example, a 4-bit exponential encoding may represent a range of urgency values. More specifically, an encoded value of 0 may represent expiry imminence less than 100 μs, a value of 1 may represent 100 to 200 μs, a value of 2 may represent 200 to 400 μs, and so forth, with increasing urgency bins covering wider intervals. The logarithmic representation enables the signaling of a wide range of latency values using only 3 to 4 bits.

In some embodiments, a floating-point encoding may be used to achieve a balance between range and precision. In such configurations, the encoded value may include a 3-bit mantissa and a 3-bit exponent, which together represent the expiry imminence in time units such as 64, 100, or 128 μs. Floating-point encoding enables both wide dynamic range and relatively fine granularity in encoding expiry imminence values.

Following the encoding process, the AP 1 transmits the expiry imminence metric to AP 2 via an inter-AP signaling message, such as a message defined by the AQRP. AP 2 is one of the peer APs participating in the same MAPC group. The exchange enables AP 2 (and potentially other MAPC participants) to consider the urgency of flows buffered or coordinated by AP 1 when making scheduling decisions in upcoming transmission intervals. The encoded expiry imminence value may be inserted into an Information Element (IE) or subelement within a broader coordination element. For example, the AQRP frame may include a flow descriptor or traffic status report element, and expiry imminence may appear as a subfield associated with a specific TID, STA address, or stream classification. In other embodiments, the expiry imminence metric may be carried as part of a standalone field in a lightweight signaling format when reduced overhead is preferred.

Through the sharing of flow-level metadata, APs gain visibility to the relative urgency of each other's buffered traffic. APs may move beyond static AC prioritization and make dynamic scheduling choices based on actual delivery constraints. The disclosed mechanism is particularly suitable for enterprise deployments, where the network often supports a mix of latency-sensitive applications (e.g., AR/VR, real-time video conferencing, or industrial automation), each with different QoS requirements and behaviors. In such environments, expiry imminence sharing enables coordinated prioritization that reflects real-time flow urgency and improves both system responsiveness and overall quality of service.

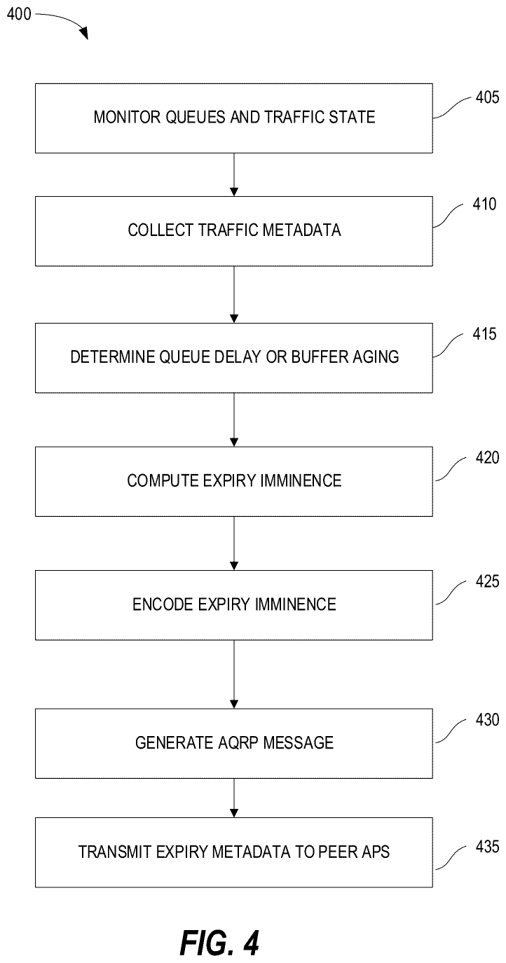

FIG. 4 depicts an example method for computing, encoding, and reporting expiry imminence in a MAPC environment, according to some embodiments of the present disclosure. The examiner method may be performed by an AP, such as APs 110 as depicted in FIG. 1 or APs 310 as depicted in FIG. 3, or other network infrastructure components, such as a WLC, a mesh coordinator, or a gateway router, provided the devices participate in or manage MAPC procedures.

At block 405, an AP (e.g., AP 310-1 of FIG. 3) monitors its local transmission queues and traffic state. For DL traffic, the operation may include inspecting the state of buffered packets across different TIDs or per-flow queues. For UL traffic, the AP prepares to solicit queue state from associated STAs (e.g., STA 305 of FIG. 3) that buffer traffic locally.

At block 410, the AP collects traffic metadata relevant to expiry estimation, including information such as application-defined delay bounds, MSDU timeout values, SCS QoS characteristics, or scheduling profiles like TWT. In the embodiment of UL traffic, the operation may also involve sending a scheduling request to the STA and receiving a BSR that may include queue depths, HOL delay, or other inferred flow parameters.

At block 415, the AP determines the current queue delay or estimated buffering duration for one or more data flows directly from internal timestamps (for DL) or inferred from client reports (for UL).

At block 420, the AP computes the expiry imminence value. The specific computation method may vary, using one of the aforementioned equations, such as subtracting queue delay from an absolute expiry time, a bounded delay threshold, or an expected transmission window.

At block 425, the AP proceeds to encode the computed expiry imminence into a compact representation. Encoding schemes may include fixed-width integer encoding (e.g., 6-8 bits in milliseconds or time units), exponential encoding, or floating-point encoding (e.g., 3-bit mantissa and 3-bit exponent).

At block 430, the AP generates a MAPC coordination message, such as an AQRP message, that includes the encoded expiry imminence value. The message may also include flow identifiers, associated TID values, or other scheduling metadata.

At block 435, the AP transmits the expiry imminence report to one or more neighboring APs (e.g., AP 310-2 of FIG. 3) that participate in the same MAPC domain. The receiving APs may use the received information to coordinate scheduling decisions.

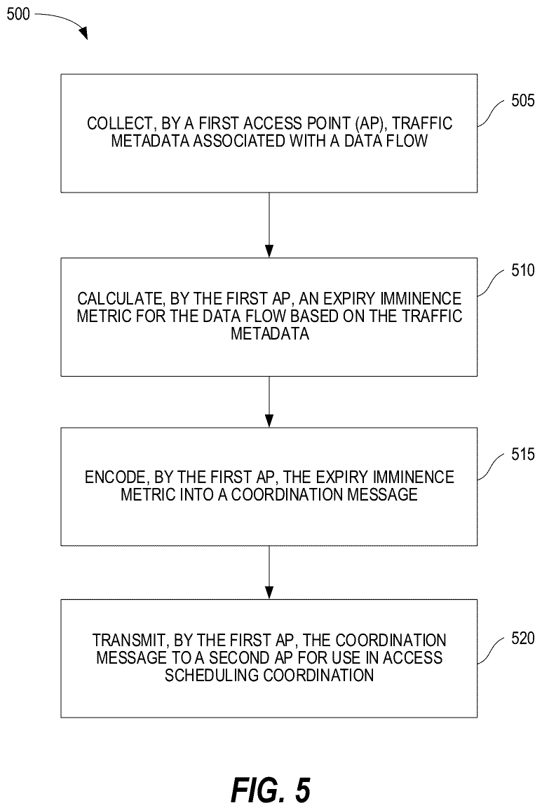

FIG. 5 is a block diagram depicting a method 500 for expiry imminence computation and reporting, according to some embodiments of the present disclosure.

At block 505, a first AP (e.g., AP 1 (310-1) of FIG. 3) collects traffic metadata associated with a data flow (e.g., msduExpiryDelay, queueDelay, delayBound, expectedStartTime).

At block 510, the first AP calculates an expiry imminence metric (e.g., expiryImminence) for the data flow based on the traffic metadata.

At block 515, the first AP encodes the expiry imminence metric into a coordination message (e.g., AQRP frame).

At block 520, the first AP transmits the coordination message to a second AP (e.g., AP 2 (310-2) of FIG. 3) for engaging in access scheduling coordination.

In some embodiments, the operation of collecting the traffic metadata may comprise retrieving a queue delay from a downlink (DL) transmission queue, or extracting, from one or more management frames, at least one of a delay bound (e.g., delayBound), a media access control (MAC) service data unit (MSDU) expiry delay (e.g., msduExpiryDelay), or an expected start time associated with the data flow (e.g., expectedStartTime).

In some embodiments, the operation of collecting the traffic metadata may comprise transmitting, by the first AP, a buffer status request to a station (STA), and receiving, by the first AP, a buffer status report comprising at least one of a queue depth or a head-of-line (HOL) delay for uplink (UL) traffic buffered at the STA.

In some embodiments, the operation of calculating the expiry imminence metric may comprise applying at least one of subtracting a queue delay from a delay bound, subtracting a queue delay from a media access control (MAC) service data unit (MSDU) expiry delay, or subtracting a current time from an expected start time.

In some embodiments, the operation of transmitting the coordination message may comprise at least one of transmitting the coordination message as part of an access point query report protocol (AQRP) message between the first AP and the second AP, or transmitting the coordination message to a wireless controller for coordination.

In some embodiments, the operation of encoding the expiry imminence metric into a coordination message may comprise encoding the expiry imminence metric as a fixed-point value using a predefined number of bits, the fixed-point value representing a time duration in a time unit.

In some embodiments, the operation of encoding the expiry imminence metric into a coordination message may comprise encoding the expiry imminence metric using an exponential scale, where each encoded value represents a time duration range that increases exponentially with the encoded value.

In some embodiments, the operation of encoding the expiry imminence metric into a coordination message may comprise encoding the expiry imminence metric as a floating-point value comprising a mantissa and an exponent, the floating-point value representing a time duration in a time unit.

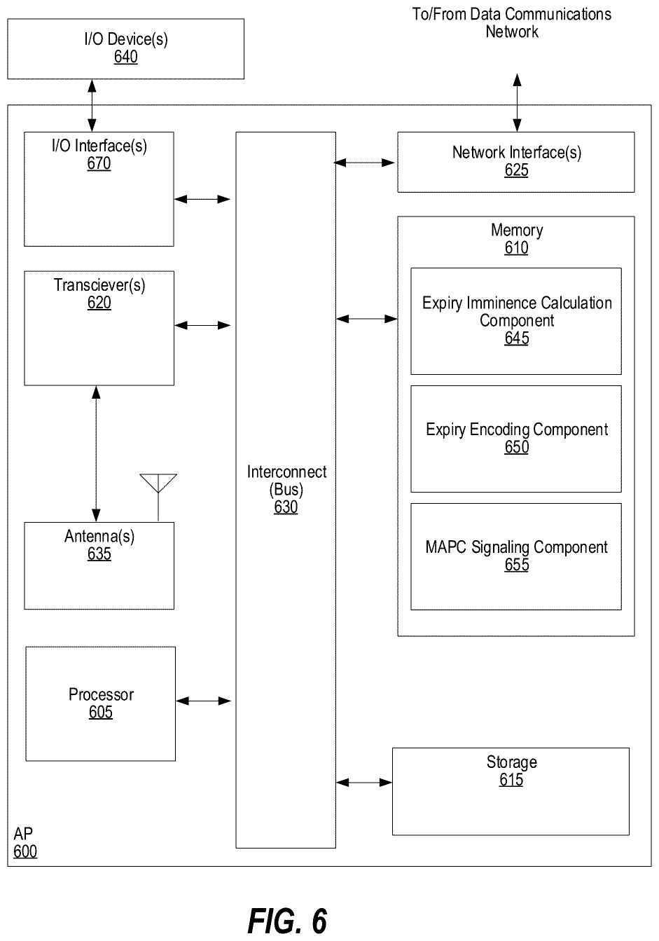

FIG. 6 depicts an example network device 600 configured to perform various aspects of the present disclosure, according to some aspects of the present disclosure.

The example network device 600 may correspond to the APs 110 as depicted in FIG. 1, AP 310 as depicted in FIG. 3, or any other network devices participating in or managing MAPC procedures (e.g., an AP of a multi-link device (MLD), a wireless controller, a router, a gateway device, a logical radio within a virtualized AP platform, or a cloud-based server).

As illustrated, the network device 600 includes a processor 605, memory 610, storage 615, one or more transceivers 620, one or more I/O interfaces 680, and one or more network interfaces 625. In some embodiments, I/O devices 670 are connected via the I/O interface(s) 680. Further, via the network interface 625, the network device 600 can be communicatively coupled with one or more other devices and components (e.g., via a network, which may include the Internet, local network(s), and the like). Each of the components is communicatively coupled by one or more buses 630. In some embodiments, one or more antennas 635 may be coupled to the transceivers 620 for transmitting and receiving wireless signals.

The processor 605 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 605 processes information received through the transceiver 620, I/O interfaces 680, and the network interfaces 625. The processor 605 retrieves and executes programming instructions stored in memory 610, as well as stores and retrieves application data residing in storage 615.

The storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 615 may store a variety of data for the efficient functioning of the system.

The memory 610 may include random access memory (RAM) and read-only memory (ROM). The memory 610 may store processor-executable software code containing instructions that, when executed by the processor 605, enable the network device 600 to perform various functions described herein for wireless communication. The memory 610 includes an expiry imminence calculation component 645, an expiry encoding component 650, and a MAPC signaling component 655.

In one embodiment, the expiry imminence calculation component 645 is configured to compute expiry imminence using one of the supported equations based on available metadata.

In one embodiment, the expiry encoding component 650 is configured to encode the computed expiry imminence value into a compact signaling format (e.g., fixed-width, exponential, or floating-point).

In one embodiment, the MAPC signaling component 655 generates and processes inter-AP signaling messages (e.g., AQRP) that carry expiry imminence and other coordination data.

Although depicted as a discrete component for conceptual clarity, in some embodiments, the operations of the depicted components (and others not illustrated) may be combined or distributed across any number of components. Further, although depicted as software residing in memory 610, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including elements A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
collecting, by a first access point (AP), traffic metadata associated with a data flow;
calculating, by the first AP, an expiry imminence metric for the data flow based on the traffic metadata;
encoding, by the first AP, the expiry imminence metric into a coordination message; and
transmitting, by the first AP, the coordination message to a second AP for engaging in access scheduling coordination.

2. The method of claim 1, wherein collecting the traffic metadata comprises:
retrieving a queue delay from a downlink (DL) transmission queue; or
extracting, from one or more management frames, at least one of:
a delay bound,
a media access control (MAC) service data unit (MSDU) expiry delay, or
an expected start time associated with the data flow.

3. The method of claim 1, wherein collecting the traffic metadata comprises:
transmitting, by the first AP, a buffer status request to a station (STA); and
receiving, by the first AP, a buffer status report comprising at least one of a queue depth or a head-of-line (HOL) delay for uplink (UL) traffic buffered at the STA.

4. The method of claim 1, wherein calculating the expiry imminence metric comprises applying at least one of:
subtracting a queue delay from a delay bound,
subtracting a queue delay from a media access control (MAC) service data unit (MSDU) expiry delay, or
subtracting a current time from an expected start time.

5. The method of claim 1, wherein transmitting the coordination message comprises at least one of:
transmitting the coordination message as part of an access point query report protocol (AQRP) message between the first AP and the second AP, or
transmitting the coordination message to a wireless controller for coordination.

6. The method of claim 1, wherein encoding the expiry imminence metric into a coordination message comprises encoding the expiry imminence metric as a fixed-point value using a predefined number of bits, the fixed-point value representing a time duration in a time unit.

7. The method of claim 1, wherein encoding the expiry imminence metric into a coordination message comprises encoding the expiry imminence metric using an exponential scale, wherein each encoded value represents a time duration range that increases exponentially with the encoded value.

8. The method of claim 1, wherein encoding the expiry imminence metric into a coordination message comprises encoding the expiry imminence metric as a floating-point value comprising a mantissa and an exponent, the floating-point value representing a time duration in a time unit.

9. A system of a first access point (AP), comprising:
one or more computer processors; and
one or more memories collectively containing one or more programs, which, when executed by the one or more computer processors, perform an operation, the operation comprising:
collecting, by the first AP, traffic metadata associated with a data flow;
calculating, by the first AP, an expiry imminence metric for the data flow based on the traffic metadata;
encoding, by the first AP, the expiry imminence metric into a coordination message; and
transmitting, by the first AP, the coordination message to a second AP for engaging in access scheduling coordination.

10. The system of claim 9, collecting the traffic metadata comprises:
retrieving a queue delay from a downlink (DL) transmission queue; or
extracting, from one or more management frames, at least one of:
a delay bound,
a media access control (MAC) service data unit (MSDU) expiry delay, or
an expected start time associated with the data flow.

11. The system of claim 9, wherein collecting the traffic metadata comprises:
transmitting, by the first AP, a buffer status request to a station (STA); and
receiving, by the first AP, a buffer status report comprising at least one of a queue depth or a head-of-line (HOL) delay for uplink (UL) traffic buffered at the STA.

12. The system of claim 9, wherein calculating the expiry imminence metric comprises applying at least one of:
subtracting a queue delay from a delay bound,
subtracting a queue delay from a media access control (MAC) service data unit (MSDU) expiry delay, or
subtracting a current time from an expected start time.

13. The system of claim 9, wherein transmitting the coordination message comprises at least one of:
transmitting the coordination message as part of an access point query report protocol (AQRP) message between the first AP and the second AP, or
transmitting the coordination message to a wireless controller for coordination.

14. The system of claim 9, wherein encoding the expiry imminence metric into a coordination message comprises encoding the expiry imminence metric as a fixed-point value using a predefined number of bits, the fixed-point value representing a time duration in a time unit.

15. The system of claim 9, wherein encoding the expiry imminence metric into a coordination message comprises encoding the expiry imminence metric using an exponential scale, wherein each encoded value represents a time duration range that increases exponentially with the encoded value.

16. The system of claim 9, wherein encoding the expiry imminence metric into a coordination message comprises encoding the expiry imminence metric as a floating-point value comprising a mantissa and an exponent, the floating-point value representing a time duration in a time unit.

17. One or more computer-readable media containing, in any combination, computer program code that, when executed by a computer system, performs an operation comprising:
collecting, by a first access point (AP), traffic metadata associated with a data flow;
calculating, by the first AP, an expiry imminence metric for the data flow based on the traffic metadata;
encoding, by the first AP, the expiry imminence metric into a coordination message; and
transmitting, by the first AP, the coordination message to a second AP for engaging in access scheduling coordination.

18. The one or more computer-readable media of claim 17, wherein collecting the traffic metadata comprises:
retrieving a queue delay from a downlink (DL) transmission queue; or
extracting, from one or more management frames, at least one of:
a delay bound,
a media access control (MAC) service data unit (MSDU) expiry delay, or
an expected start time associated with the data flow.

19. The one or more computer-readable media of claim 17, wherein collecting the traffic metadata comprises:
transmitting, by the first AP, a buffer status request to a station (STA); and
receiving, by the first AP, a buffer status report comprising at least one of a queue depth or a head-of-line (HOL) delay for uplink (UL) traffic buffered at the STA.

20. The one or more computer-readable media of claim 17, wherein calculating the expiry imminence metric comprises applying at least one of:
subtracting a queue delay from a delay bound,
subtracting a queue delay from a media access control (MAC) service data unit (MSDU) expiry delay, or
subtracting a current time from an expected start time.
